(19) United States
(12) Patent Application Publication
(10) Pub. No.: US 2013/0155236 A1
(43) Pub. Date: Jun. 20, 2013

(54) CAMERA-MIRROR SYSTEM FOR MOTOR VEHICLE

(71) Applicant: PRADEEP RAMDEO, Bronx, NY (US)

(72) Inventor: PRADEEP RAMDEO, Bronx, NY (US)

(21) Appl. No.: 13/327,461

(22) Filed: Dec. 15, 2011

(51) Int. Cl. H04N 7/18

(52) U.S. Cl. 348/148; 348/E07.085

(57) ABSTRACT

A CAMERA-MIRROR system for a motor vehicle which comprises a side view mirror frame coupled to the motor vehicle. A mirror is carried in the side view mirror frame. A camera is mounted in the side view mirror frame adjacent to the mirror. A screen monitor is positioned inside the motor vehicle, the screen monitor being operationally coupled to the camera. The screen monitor will display a rear image captured by the camera to a driver of the motor vehicle.

### BACKGROUND OF THE INVENTION

1. Field of the Invention

The present invention relates to a side view mirror and camera device, and more particularly, a CAMERA-MIRROR system for a motor vehicle.

Many drivers often have a blind spot while using the motor vehicle side view mirrors. The blind spot, which is an obstruction of the visual field, can make it difficult to safely maneuver the motor vehicle. With a blind spot, drivers may change lanes without realizing that there is an approaching motor vehicle in the next lane. During inclement weather, many drivers experience decreased visibility. Standard motor vehicle side view mirrors often reflect other vehicles headlights, which can impair the vision of the drivers. A more efficient option is needed.

The present invention combines a side view mirror with a camera to provide drivers with a better view. It allows for improved visibility both day and night and in any weather condition. The CAMERA-MIRROR system can be installed on a variety of motor vehicles, including cars, trucks, SUVs, buses, and more. The present invention offers a more comprehensive view of the road, which can help to improve safety and reduce accidents. Drivers will appreciate the efficiency that the CAMERA-MIRROR system provides.

2. Description of the Prior Art

Numerous innovations for vehicular mirror and camera assemblies have been provided in the prior art that will be described. Even though these innovations may be suitable for the specific individual purposes to which they address, however, they differ from the present invention.

A FIRST EXAMPLE, U.S. Patent Office Publication No. 2002/0113876, published on Aug. 22, 2002, to Kim teaches a vehicle surveillance system comprising a plurality of digital cameras mounted on a vehicle's interior and exterior for photographing the dashboard, the interior environment of the vehicle and exterior views around the vehicle to eliminate blind spots inherent to the vehicle's mirrors. A screen monitor mounted on a front panel of the vehicle displays photographed images. A removable image memory saves the photographed image information. A sound memory stores a plurality of predetermined sounds, including voice sounds, a sound detector detects sounds in close proximity to the vehicle, a sound analyzer compares a detected sound to the sounds stored in the sound memory; and an alarm generator generates an audible alarm through a speaker to the exterior of the vehicle when the sound analyzer determines the detected sound corresponds to one of the stored sounds.

A SECOND EXAMPLE, U.S. Pat. No. 6,535,242, issued on Mar. 18, 2003, to Strumolo et al. teaches an image acquisition and display system for use on a vehicle. The system includes a three-dimensional display and two stereo camera pairs which are respectively mounted on the driver-side and passenger-side of the vehicle. Camera pairs are adapted to receive images of objects located in the front of the vehicle from both sides of the vehicle regardless of the ambient light level surrounding the vehicle. A controller processes the image data from the cameras and provides three-dimensional image data to the display which utilizes the data to display the images to the driver in a three-dimensional format. A user input device allows a driver of the vehicle to select between the camera pairs to reposition the camera pairs and to selectively magnify and minimize images acquired by the cameras pairs.

A THIRD EXAMPLE, U.S. Patent Office Publication No. 2005/0146604, published on Jul. 7, 2005, to Shinada teaches a side-mirror apparatus for automobile to obtain a field of view to the rear when the side-mirror apparatus for automobile is drawn out to a drawn-out position and to be stored when not in use, specifically capable to confirm the field of view to the rear when the side-mirror apparatus for automobile is stored. A convex mirror and CCD are provided on a portion of an end side of an outer casing of the side-mirror apparatus. When a door mirror is stored, an image of a field of view to the rear is captured. The image is subject to image processing by an image processing circuit so as to be displayed on a display panel in front of a driver seat.

A FOURTH EXAMPLE, U.S. Pat. No. 6,954,152, issued on Oct. 11, 2005, to Matthews teaches a side view mirror and camera assembly for providing a mirror combined with a camera directed towards the blind spot of the mirror to allow a driver of a vehicle to view objects near the vehicle that are not viewable using the side view mirror alone. The side view mirror and camera assembly includes an adjustable camera coupled to a side view mirror housing to show a view of the blind spot of the side view mirror on a display viewable by a driver of a vehicle. In an embodiment, the camera is positioned within the side view mirror housing behind a one way portion viewing of the mirror.

A FIFTH EXAMPLE, U.S. Patent Office Publication No. 2008/0203308, published on Aug. 28, 2008, to Yoo teaches a car side mirror equipped with a thermal infrared camera. The car side mirror includes a thermal infrared camera device, a video signal transmission device, a power unit. Associated with the side mirror device is a display device inside the car. The thermal infrared camera device includes a thermal image sensor for receiving infrared signals, an electronic circuit for determining whether an obstacle exists in front of a car, and containing an individual Identification (ID), and a video output unit for converting output signals into video signals. The thermal infrared camera device photographs one or more objects in a desired direction. The video signal transmission device transmits the video signals to a display device. The power unit supplies power to the thermal infrared camera device and the video signal transmission device. The display device identifies the individual ID of the thermal infrared camera and then receives the video signals.

A SIXTH EXAMPLE, U.S. Pat. No. 7,423,521, issued on Sep. 9, 2008, to Kukita et al. teaches a vehicular CAMERA-MIRROR system, an image picked up by an image pickup device is processed by an image processing device, and displayed on a display monitor. The image pickup device is mounted on a lower part of a door mirror housing, and is capable of picking up an image of a region that is continuous in the fore-and-aft direction. The imaged region includes part of a front region directly viewed by a vehicle driver, and part of a rear region indirectly viewed by the vehicle driver via a door mirror. The image processing device displays, on the display monitor, an imaged region for which at least front and rear boundaries thereof of the viewed regions overlap. Thus, it is possible to avoid a blind spot from occurring between the direct and indirect views and the image based on the picked up image, thereby improving visibility.

A SEVENTH EXAMPLE, U.S. Pat. No. 7,446,650, issued on Nov. 4, 2008, to Scholfield et al. teaches an accessory system suitable for use in a vehicle which includes an interior rearview mirror assembly having a mirror-mounting portion that is adapted to detachably mount the interior rearview mirror assembly at an interior portion of the vehicle. A windshield accessory module assembly is also preferably included attached at the windshield of the vehicle. The windshield accessory module assembly is unaffected by adjustment of the rearward field of view of the reflective element of the interior rearview mirror assembly and preferably comprises at least one of a forward facing imaging device with a field of view forward of the vehicle through the windshield of the vehicle and an interior cabin imaging device with a field of view encompassing at least a portion of the interior cabin of the vehicle. The accessory system preferably includes a video display screen displaying an image captured by an image capture device with a field of view rearward of the vehicle.

AN EIGHTH EXAMPLE, U.S. Pat. No. 7,520,616, issued on Apr. 21, 2009, to Ooba et al. teaches a vehicular CAMERA-MIRROR system which includes: a retro-reflective surface formed on an inside face of a pillar that is in a position obstructing the view of a vehicle driver seated on a driver's seat within a vehicle compartment; a camera mounted on the vehicle outside the vehicle compartment for taking an image outward from the pillar in a direction that is substantially the same as the line of vision of the vehicle driver on the driver's seat; and a projector for projecting in real time the image taken by the camera toward the retro-reflective surface of the pillar. The projector is fixedly disposed within the vehicle compartment at a position close to the eyes of the vehicle driver on the driver's seat. Thus, it is possible to eliminate a blind spot due to the pillar, thereby enhancing safety of driving.

A NINTH EXAMPLE, U.S. Patent Office Publication No. 2009/0143967, published on Jun. 4, 2009, to Lee et al. teaches a motor vehicle that has a wheel-view camera with a wide-angle lens and an image sensor. The wheel-view camera is mounted in the housing of a side view mirror and points in a downward direction such that the wheel-view camera captures a front wheel. An image processing unit is operatively connected to the wheel-view camera unit for receiving image data from the wheel-view camera. The image processing unit is configured to process the image data such that the image processing unit performs a wide-angle lens correction, an image rotation and a viewpoint conversion. A display unit is operatively connected to the image processing unit. The display unit receives processed image data from the image processing unit and displays an image of the front wheel.

A TENTH EXAMPLE, U.S. Patent Office Publication No. 2010/0066833, published on Mar. 18, 2010, to Ohshima et al. teaches a vehicle surroundings monitoring apparatus which includes: a plurality of imaging units which capture an external region of a present-vehicle and output images; a display unit which is installed in an interior of the present-vehicle; an image combined unit which combines the images output from the imaging units and outputs a combined image; and a display control unit which displays the combined image output from the image combined unit on the display unit, wherein at least one of the imaging units is installed at a retractable side mirror of the present-vehicle, and the image combined unit extracts extracted images of an extraction range determined for respective images output from the imaging units, combines the extracted images to generate the combined image, and changes the extraction range and a boundary position between the extracted images constituting the combined image depending on extension and retraction of the side mirror.

It is apparent now that numerous innovations for vehicular mirror and camera assemblies have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a CAMERA-MIRROR system for a motor vehicle that avoids the disadvantages of the prior art.

ANOTHER OBJECT of the present invention is to provide a CAMERA-MIRROR system for a motor vehicle that is simple and inexpensive to manufacture.

STILL ANOTHER OBJECT of the present invention is to provide a CAMERA-MIRROR system for a motor vehicle that is simple to use.

BRIEFLY STATED, STILL YET ANOTHER OBJECT of the present invention is to provide a CAMERA-MIRROR system for a motor vehicle which comprises a side view mirror frame coupled to the motor vehicle. A mirror is carried in the side view mirror frame. A camera is mounted in the side view mirror frame adjacent to the mirror. A screen monitor is positioned inside the motor vehicle, the screen monitor being operationally coupled to the camera. The screen monitor will display a rear image captured by the camera to a driver of the motor vehicle.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a block diagram showing the various components of the present invention;

FIG. 2 is a perspective view showing the side view mirror with the integrated camera; and

FIG. 3 is a perspective view showing the screen monitor within the motor vehicle being viewed by the driver.

### REFERENCE NUMERALS UTILIZED IN THE DRAWING

110 CAMERA-MIRROR system
112 motor vehicle
114 side view mirror frame of system 110
116 mirror of system 110
118 camera of system 110
120 screen monitor of system 110
122 rear image display on screen monitor 120
124 driver of motor vehicle 112
126 night vision circuit in camera 118
128 control unit in motor vehicle 112
130 zoom circuit in camera 118
132 adjustable position device of system 110
134 turn signal indicator lights of system 110
136 small hood or snow guard over camera 118

### DETAILED DESCRIPTION OF THE PREFERRED EMBODIMENT

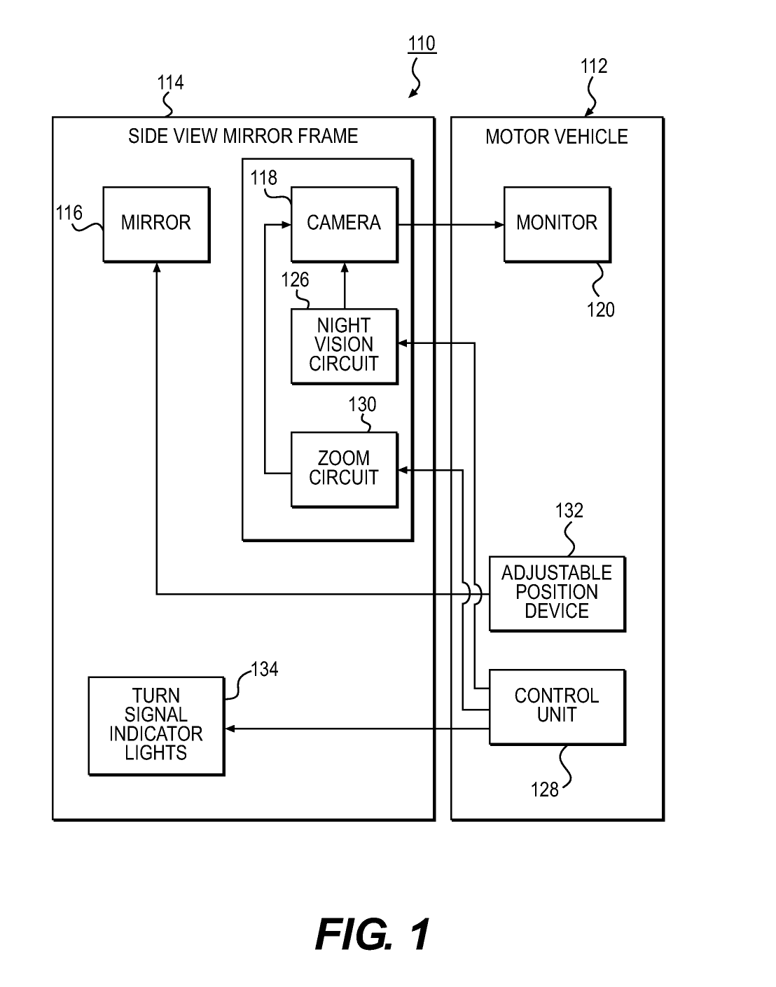

As shown in FIG. 1, the present invention is a CAMERA-MIRROR system 110 for a motor vehicle 112 which comprises a side view mirror frame 114 coupled to the motor vehicle 112. A mirror 116 is carried in the side view mirror frame 114 for providing a first viewing to a driver 124. A camera 118 is mounted in the side view mirror frame 114 adjacent to the mirror 116 for providing a second additional viewing angles (e.g. rear image 122) (e.g. 10 degrees to 45 degrees) or wider viewing angles to the driver 124. A screen monitor 120 is positioned inside the motor vehicle 112, the screen monitor 120 being operationally coupled to the camera 118. The side view mirror 116 has a size of 5 inches×8 inches.

The camera 118 comprises a night vision circuit 126, whereby the camera 118 has the capability to detect the rear image at night (e.g. using thermal infrared camera). A control unit 128 within the motor vehicle 112 is coupled to the night vision circuit 126 to allow the driver 124 to activate the night vision circuit 126. The camera 118 further comprises a zoom circuit 130 coupled to the control unit 128 to allow the driver 124 to activate the zoom circuit 130 to adjust distance and give the driver 124 the ability to reduce brightness from headlights at night and from sunlight during the day. An adjustable position device 132 within the motor vehicle 112 is coupled to the mirror 116 to allow the driver 124 to properly angle the mirror 116 and see the rear image behind the motor vehicle 112.

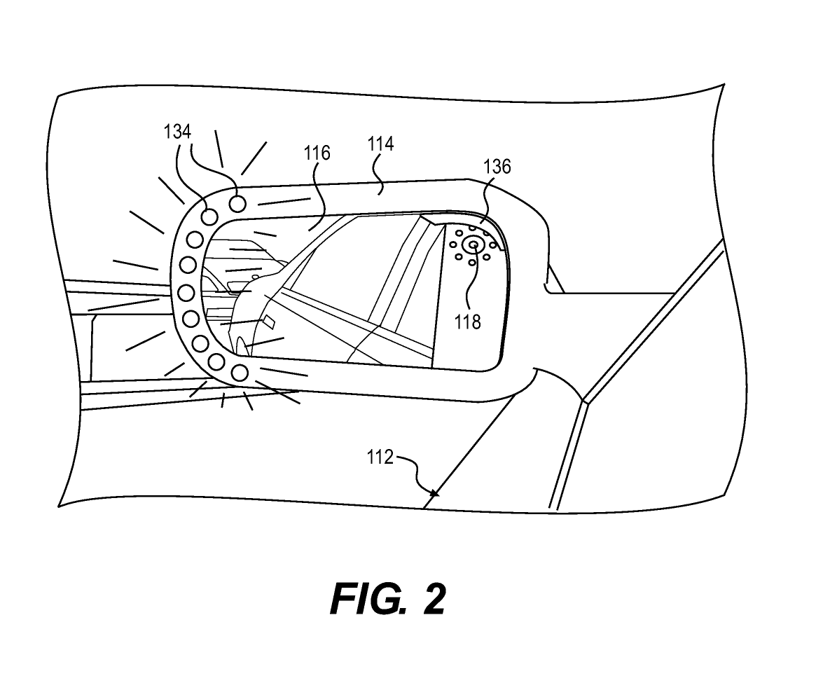

As shown in FIG. 2, turn signal indicator lights 134 (e.g. light emitting diodes LEDs) on an outer portion of the side view mirror frame 114 are coupled to the control unit 128 to allow the driver 124 to activate the turn signal indicator lights 134 (e.g. light emitting diodes LEDs). A small hood or snow guard 136 extends over the camera 118 to protect the camera 118 from rain and snow.

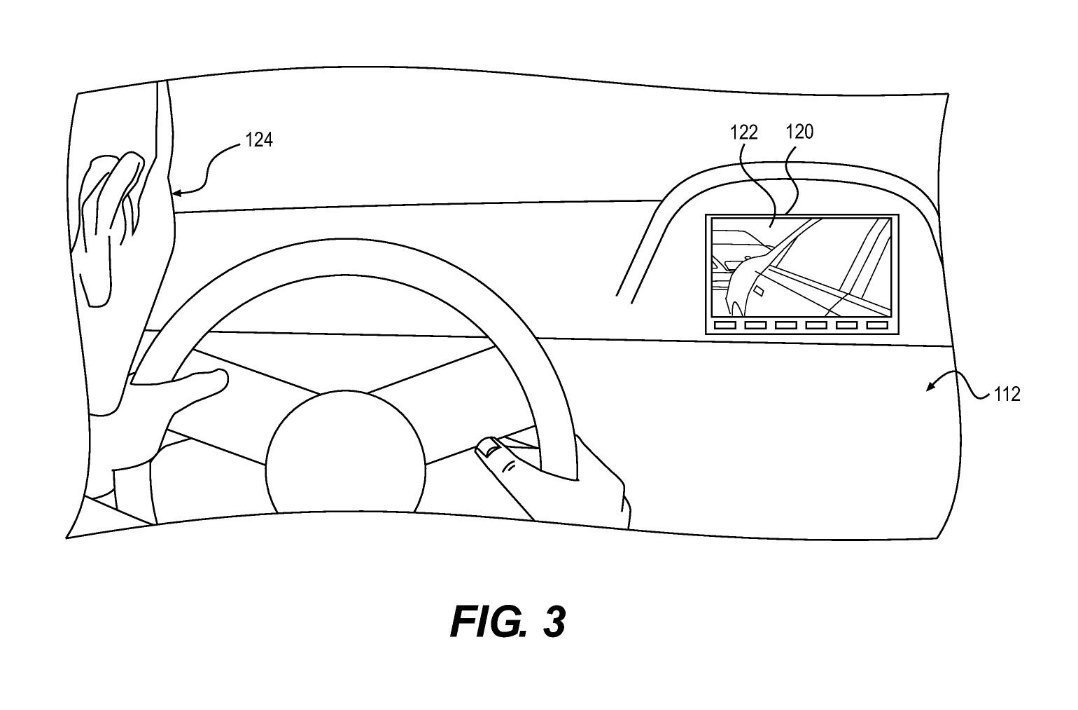

As shown in FIG. 3, the screen monitor 120 will display a rear image 122, captured by the camera 118 to a driver 124 of the motor vehicle 112.

In review, the CAMERA-MIRROR system 110 provides a driver 124 with a better view of the road while driving. The present invention is comprised of a side view mirror frame 114 that is similar in appearance to a traditional side view mirror frame, with the exception of an integrated camera 118. The side view mirror frame 114 may be made for both the left and right side of a motor vehicle 112. A mirror 116 may be slightly recessed inside the side view mirror frame 114 and there is a small hood 136 covering the area where the camera 118 is located. The mirror 116 is able to tilt left or tilt right by an adjustable position device 132. The camera 118 equipped with a night vision circuit 126 and a zoom circuit 130 is operable by a control unit 128. The zoom circuit 130 adjusts the distance and gives the driver 124 more control over what is seen. The zoom circuit 130 also is used to reduce brightness from headlights and from sunlight.

The camera 118 may be positioned in the upper right corner of the side view mirror frame 114 or other suitable location and is coupled to a screen monitor 120 to display a rear image 122. The camera 118 may be concealed and protected from rain and snow. Multiple cameras 118 may be used if desired. The camera 118 may also be installed without the mirror 116 if desired. The side view mirror frame 114 may be available in various shapes and sizes to accommodate all types of motor vehicles 112. The system 110 also includes turn signal indicator lights 134. It may also be fully compatible with most navigation and DVD deck systems, monitors, DVRs, and other video equipment. The system 110 is not limited to the features listed above. The exact specifications may vary.

It will be understood that each of the elements described above, or two or more together, may also find a useful application in other types of constructions differing from the types described above.

While the invention has been illustrated and described as embodiments of a CAMERA-MIRROR system for a motor vehicle, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A CAMERA-MIRROR system for a motor vehicle which comprises:
a) a side view mirror frame coupled to the motor vehicle;
b) a mirror carried in the side view mirror frame for providing a first viewing to a driver;
c) a camera mounted in the side view mirror frame adjacent to the mirror for providing a second additional viewing to the driver; and
d) a screen monitor positioned inside the motor vehicle, the screen monitor being operationally coupled to the camera, whereby the screen monitor will display a rear image captured by the camera to the driver of the motor vehicle.

2. The system as recited in claim 1, wherein the camera comprises:
a) a night vision circuit, whereby the camera has the thermal infrared capability to detect the rear image at night; and
b) a control unit within the motor vehicle coupled to the night vision circuit to allow the driver to activate the night vision circuit.

3. The system as recited in claim 2, wherein the camera further comprises a zoom circuit coupled to the control unit to allow the driver to activate the zoom circuit to adjust distance and give the driver the ability to reduce brightness from headlights at night and from sunlight during the day.

4. The system as recited in claim 1, further comprising an adjustable position device within the motor vehicle coupled to the mirror to allow the driver to properly angle the mirror and see the rear image behind the motor vehicle.

5. The system as recited in claim 2, further comprising turn signal indicator lights on an outer portion of the side view mirror frame are coupled to the control unit to allow the driver to activate the turn signal indicator lights.

6. The system as recited in claim 1, further comprising a small hood extending over the camera to protect the camera from rain and snow.

7. The system as recited in claim 1, wherein the side view mirror frame is 5 inches by 8 inches in size.

8. The system as recited in claim 1, wherein the second additional viewing angle is from 10 degrees to 45 degrees.
